(19) United States
(12) Patent Application Publication
(10) Pub. No.: US 2008/0071553 A1
(43) Pub. Date: Mar. 20, 2008

(54) Generation of Commercial Presentations

(75) Inventors: Youssef Hamadi, Cambridge (GB); Carsten Rother, Cambridge (GB)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/465,335

(22) Filed: Aug. 17, 2006

(51) Int. Cl. G06Q 10/00

(52) U.S. Cl. 705/1

(57) ABSTRACT

A method of compiling information relating to an item from an image of that item is described, where the image may be a still image or a moving image (e.g. a video clip). The image data contains embedded data about the item and this embedded data is extracted from the image and used to search for information on the item. The information found in the search can then be compiled and the compiled information may be used to advertise the item, for example, through publication of the information on the internet.

### BACKGROUND

Sale of second hand or used goods via commercial websites, such as online auction websites, has become very popular. However, as the goods are not being sold by the original manufacturer or retailer, the product description written by the seller which usually accompanies pictures or videos of the item being sold is often brief and may be unreliable.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

A method of compiling information relating to an item from an image of that item is described, where the image may be a still image or a moving image (e.g. a video clip). The image data contains embedded data about the item and this embedded data is extracted from the image and used to search for information on the item. The information found in the search can then be compiled and the compiled information may be used to advertise the item, for example, through publication of the information on the internet.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of a network for selling goods;

FIG. 2 is an example flow diagram showing the operation of a web server;

FIG. 3 shows a schematic diagram of a context sensitive camera system;

FIG. 4 is an example flow diagram showing a step of the method of FIG. 2 in more detail;

FIG. 5 is a second example flow diagram showing the operation of a web server;

FIG. 6 is a third example flow diagram showing the operation of a web server; and

FIG. 7 shows a schematic diagram of an apparatus for performing the methods of FIG. 2, 5 or 6.

### Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

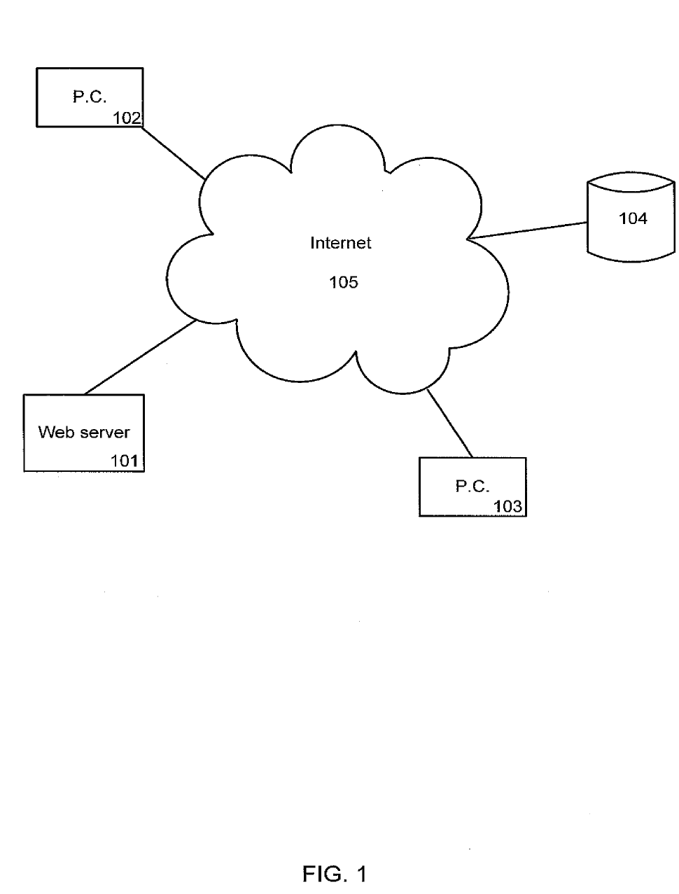

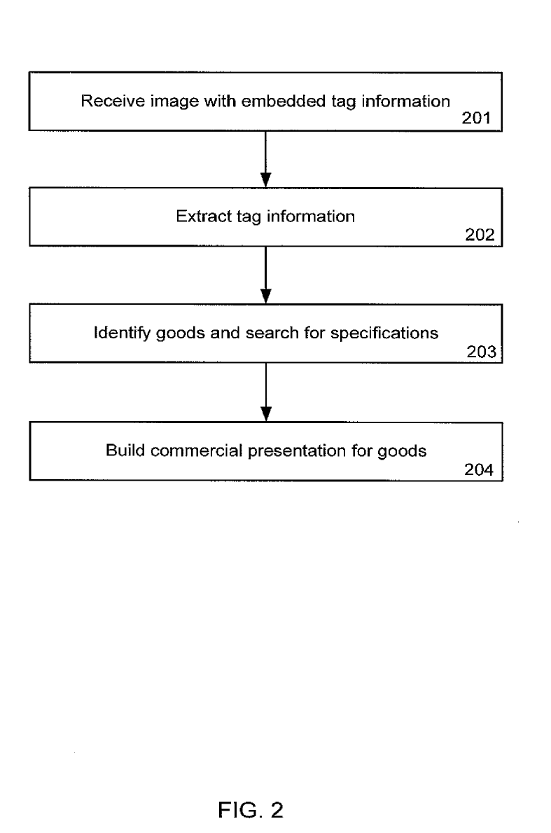

FIG. 1 is a schematic diagram of a network for selling goods via a commercial website which comprises a web server 101, a seller's computer 102, a potential buyer's computer 103 and a database 104 which are all connected to the internet 105. The process of placing an item for sale on a commercial website hosted by the web server 101 and the operation of the web server 101 can be described with reference to the example flow diagram in FIG. 2. A seller who has an item to sell takes a photograph of the item and uploads the image with embedded data about the item to a commercial website hosted by a web server 101 using the seller's computer 102 which is connected to the internet 105. The data about the item may be embedded within the image file by the seller's camera, the seller's computer or other apparatus (which may or may not be associated with the seller) and some example methods are described in more detail below. In another example, the image may not be taken by the seller, but instead the seller may obtain the picture from another channel (e.g. downloaded from the web) and then upload it for use in selling the seller's own item (e.g. a seller selling a used car may take a picture from the manufacturer's website which contains the embedded data. The web server 101 receives an image (step 201) and extracts the data about the item from the image (step 202). From the data, the web server 101 identifies the item and searches for a specification for the item (step 203). This may require the web server searching one or more databases, such as database 104. Having found a specification for the item, the web server compiles the information and builds a commercial presentation for the item (step 204) using the image and the specification. This presentation (or other form of the compiled information) may then be displayed on the website such that it can be viewed by a potential buyer via their computer 103. The website may be an online auction website or any other web site where goods may be sold. In another example, the commercial website may be hosted by a second web server (not shown in FIG. 1) instead of web server 101. In this example the web server 101 may provide the prepared presentation to either the seller or to the second web server hosting the commercial website. The method steps are described in more detail below.

The image received by the web server (in step 201) may comprise an image in JPEG, TIFF or any other format. The data may be embedded in the image as metadata, for example as defined in the Exif (Exchangeable image file format) standard or using XMP (Extensible Metadata Platform) or IPTC (International Press Telecommunications Council) headers. Alternatively, the data may be embedded in the image in any other way. The image may be a still image or may be a moving image, such as a short video clip.

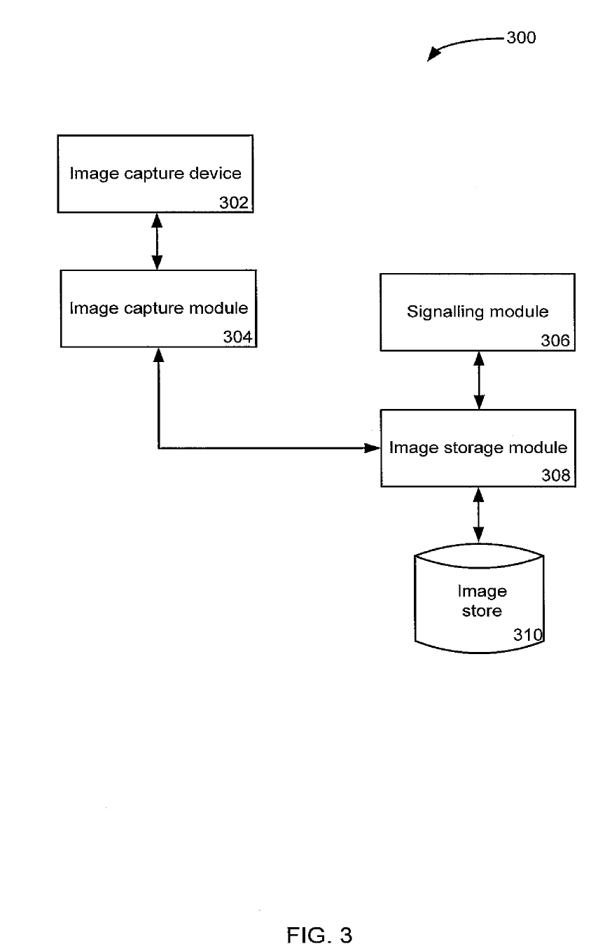

The image with embedded data may, in an example, have been created using a context sensitive camera as described in co-pending U.S. patent application Ser. No. 10/659,121, Publication No. 2005/0052535 which is incorporated herein by reference. FIG. 3 shows a schematic diagram of a context sensitive camera system 300 which comprises an image capture device 302 such as a still camera or a video camera coupled to an image capture module 304 which processes an image captured by the image capture device 302. The system 300 also comprises a signaling module 306 which wirelessly transmits one or more identification requests to objects in the vicinity of the image capture device 302. These requests may use RF signals or infra-red signals and may use any suitable communication protocol, including but not limited to Bluetooth and Wifi. In an example, the signaling module 306 may comprise a RFID tag reader. The signaling module 306 receives responses to the requests transmitted from capable devices within the vicinity and these responses contain identification information for objects in the vicinity. In an example where the signaling module is an RFID reader, the response may comprise the RFID tag information. This information may then be stored in association with or embedded in the image by an image storage module 308 in an image store 310. In another example, the system may also comprise an object matching module connected to the image capture module and the image storage module. The object matching module also receives the captured image and the identification information. The module then uses the identification information to determine which models to extract from a model store. These extracted models are then used to match objects contained within the image and generate parameters identifying and/or describing the objects in the image. These parameters are sent to the image storage module 308 which embeds the information in the image (or otherwise associates the information with the image) and stores it in the image store 310.

In another example, the image with embedded data may be created in other ways, including, but not limited to, use of image recognition software on the initial image. The image recognition software may recognize the whole object in the image (e.g. using a model) or may extract information from parts of the image (e.g. a barcode, a serial number or other visible feature). The image recognition software may produce an image with embedded data or the data output from the image recognition software may be embedded within the image by a separate application.

In a further example, the data may be embedded by adding the metadata manually. This may be done by the seller using a custom application or web service. Alternatively, this service may be offered by a third party.

Having received the image (in step 201), the web server extracts the embedded data (step 202). This embedded data may also be referred to as a ‘tag’. The extracted data may comprise an Electronic Product Code (EPC or ePC), a Universal Product Code (UPC), a European Article Number (EAN), a Japanese Article Number (JAN) or any other identification code which relates to an object (e.g. serial number, an RFID number etc). In another example, the extracted data may comprise data in a different format, such as the manufacturers name and the model number of the item.

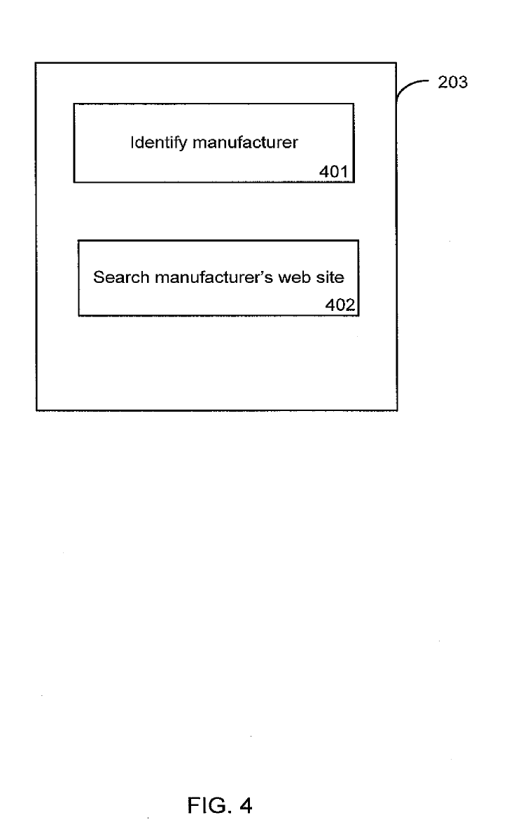

Using the extracted data (from step 202) the web server searches one or more databases to find the specification for the object (step 203) and, in some examples, additional data relating to the object, such as information on current value (e.g. from a valuation website), further images of the object (e.g. when new), advertising literature relating to the object (e.g. when first sold). The databases used may be local or remote and may be accessed via web pages e.g. using a search engine. In a first example, as shown in FIG. 4, the web server first identifies the manufacturer of the item using a first database (step 401). This first database may be a local database or a remote database and may comprise a third party service such as a central register for a particular type of code. Having identified the manufacturer of the item, the web server then accesses the website of the manufacturer and searches for specifications or other information relating to the particular item (step 402). In a second example, all the information may be provided on a single database, such as a third party service linking product codes (such as those listed above) to specification and/or other product information. In a third example, the web server may use a search engine, such as MSN (trade mark) to find the specifications and/or other information relating to the product.

Having obtained the information relating to the item (in step 203), the web server compiles this information into a commercial presentation for the item (step 204). The information which is compiled may comprise one or more pieces of information collected from one or more sources (e.g. from different databases, search engines, websites etc). The commercial presentation may be in the form of a web page with links to the additional information which may be stored on the web server or the links may direct the viewer to the source of the information (e.g. the manufacturer's website). The presentation may then be published on the web server or on another web server or alternatively, the presentation may be provided to the seller for them to publish. The presentation may be published on an online auction website or other commercial website. In another example, the commercial presentation may be in the form of sales documentation, an advertisement etc.

By obtaining information in addition to that provided by the seller (or instead of that provided by the seller), such as information from the original manufacturer, the information provided to a potential buyer relating to an item is more complete and more reliable. This provides the seller with a better sales presentation and may increase the chance that the item is sold whilst the potential buyer may have greater confidence in the information provided on the item for sale and may therefore be more inclined to make a purchase. As benefits may exist for both the seller and the buyer, this provides the operator of the commercial website with a more robust business.

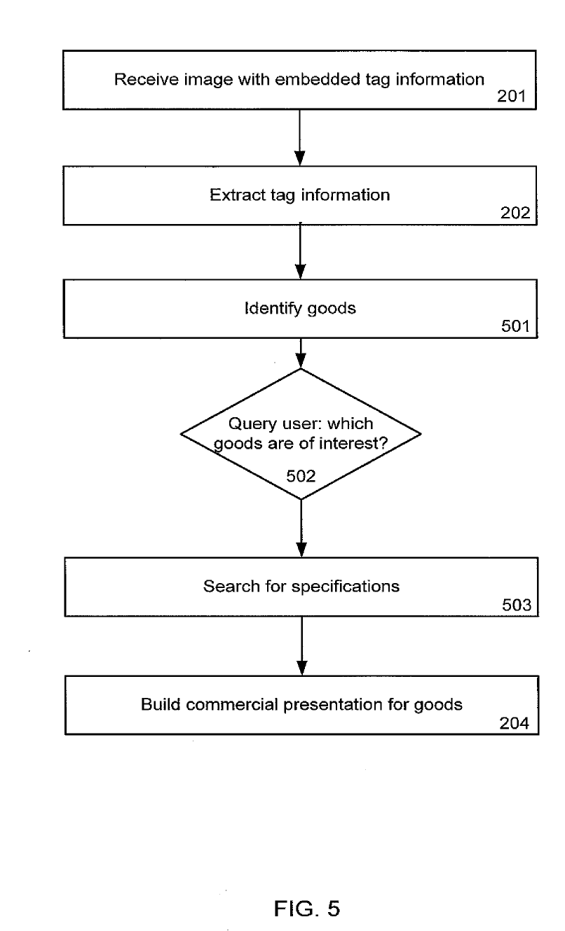

In some examples, the extracted data may comprise data relating to more than one object (e.g. it contains two ePCs). In such an example, the web server may identify each of the items, search for specifications for each item and build a presentation for each item or a presentation for all of the items together (e.g. steps 203 and 204 are performed for each item referenced within the extract data). In another example, each of the goods may be identified (step 501) and the user may be prompted to identify which of the items the user requires a presentation for (step 502), as shown in FIG. 5. Where the user indicates that more than one item is of interest, the user may be further prompted to indicate whether one combined presentation or individual presentations are required (not shown in FIG. 5). The responses to these prompts received by the web server therefore influence how many items are searched (in step 503) and how many presentations are built (in step 204).

In the description above, specification data relating to the identified item is searched for (in step 203). The specification of an item is one example of the information relating to the item that may be searched for and in addition, or instead, the search may be performed to identify other information relating to the item. Examples include, but are not limited to, user instructions, test data, reviews of the item (e.g. as produced by consumer organizations or buyers of similar items whether new or used), valuations, data on comparable items (e.g. specifications, valuations etc), sales literature, images, information on other sales of the same type of item (e.g. data on the sale prices of identical or similar items on the particular commercial website or on other websites) and safety information (e.g. safety data sheets).

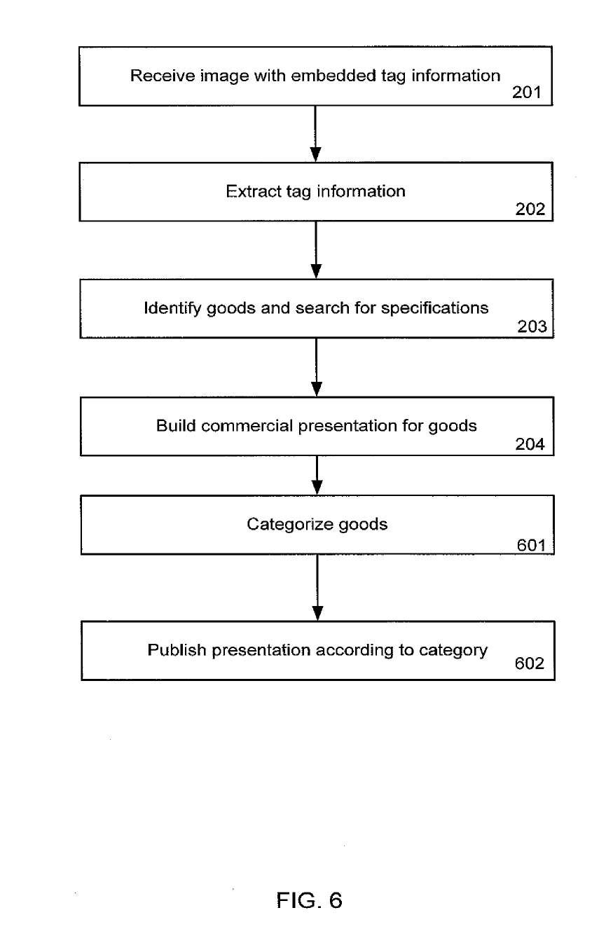

FIG. 6 shows another example flow diagram for the operation of the web server 101. The presentation is built as described above in relation to FIG. 2 (steps 201-204) and the extracted data is used to categorize the item (step 601) within a structure (such as a tree structure) defined by the web server or by another entity such as the commercial website on which the presentation is to be published. In another example, the item may be categorized according to a system defined by a standards body or other third party. For example, a commercial website, such as an online auction site, may classify items under the following categories and sub-categories:
Electricals
   Household goods
   Office equipment
Cars
   Standard cars
   Sports cars
   People carriers
   Convertible cars
      An item may be identified as a sports car and this may be categorized under ‘cars’ and/or it may be placed in a sub-category ‘sports cars’ (in step 601). Once the item has been categorized, the category information may then be used when the compiled presentation is published (step 602) such that the presentation is located at the right point within the structure of the web site and/or that the presentation can be located by a potential buyer searching by category (and sub-category, where appropriate). The category information may also be included within the commercial presentation. It will be appreciated that an item may be placed within more than one category or sub-category (e.g. a convertible sports car may be placed within both sub-categories: ‘sports cars’ and ‘convertible cars’).

By automatically categorizing the items and using this category information within the website, errors in categorization are minimized and therefore searching by potential buyers will provide more accurate results. Additionally it provides the operators of the commercial website with more accurate information on what is for sale/sold on the site allowing them to generate more accurate statistics.

Although the above methods are particularly applicable to the sale of used (i.e. not new or second hand) goods, for example by an individual who may have been the original buyer of the goods, the methods are also applicable to the sale of new goods, for example by a third party who is not the manufacturer of goods and therefore does not necessarily have all the specification and other details. The third party may be an individual (e.g. who bought the goods but has not used them) or a commercial enterprise (e.g. a shop or online business).

In the above examples, the compiled information (in the form of a presentation) is published on a website. In another example, however, the method may be used to compile information which may be used in selling the item by other means e.g. in a shop, newspaper etc. The compiled information may comprise an advert, a sales brochure etc which may be printed or displayed to potential buyers via other media (e.g. television, radio).

In the above examples, the information on the item or on a group of items is compiled in order that the item (or items) can be advertised for sale. However, the compiled information may be used for other purposes, some examples of which are described below.

In an example, the methods described above may be used to obtain a valuation of property e.g. of all the items in a house. In such an example, multiple images may be received and the images may contain information on many items (e.g. where a photograph is taken of each room in the house). In searching for information on each item (in step 203), in addition to (or instead of) accessing specifications for the items, valuations of the items may be accessed in order that the compiled information (in step 204) includes a valuation of all the items and may include a total valuation. This may then be used to determine the insurance required on a property. In another example, the compiled information may include details (such as specifications) of each item and this may be sent to an insurance company which determines the required level of insurance. By having such an accurate and detailed inventory of items within the house, the process of replacing items if they are stolen/broken etc is simplified as there is a good record of the details relating to each item.

In another example, the methods described above may be used to obtain an inventory of the items within a property e.g. when selling or renting that property. As in the previous example, multiple images may be received and each image may contain embedded information relating to one or more items. The information compiled (in step 204) may comprise a list of all the items with links to additional information on those items, which may include user instructions and other details (e.g. specifications, valuations etc). Such a list may be useful to the person renting/selling the house and also to the tenant/purchaser because it provides information on all the items in a central place and may include information that might otherwise not be available (such as user instructions).

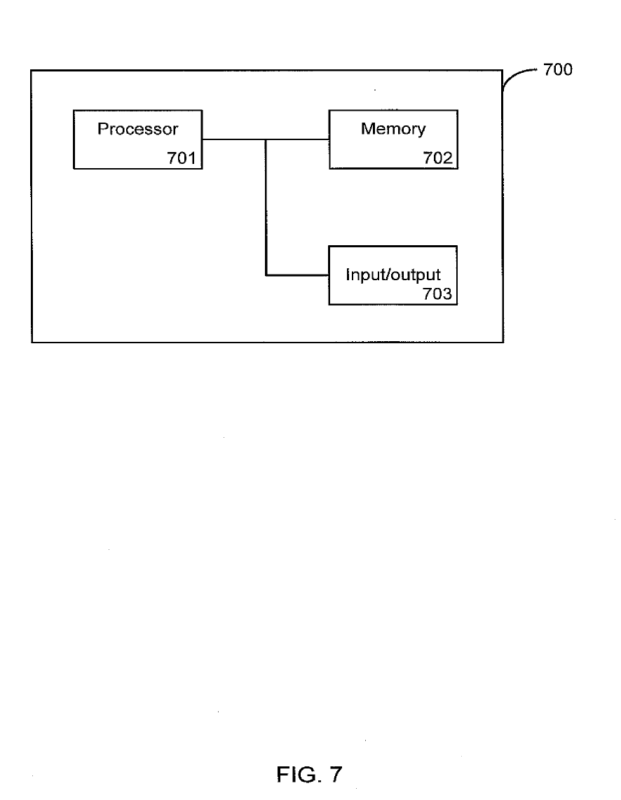

FIG. 7 shows a schematic diagram of an apparatus 700 for performing the above methods (such as web server 101). The apparatus comprises a processor 701, a memory 702 arranged to store executable instructions arranged to cause the processor to perform some or all of the method steps described above. The apparatus further comprises an input/output 703 via which the images containing the embedded data are received.

Although the present examples are described and illustrated herein as being implemented in a web based system as shown in FIG. 1, the system described is provided as an example and not a limitation. As those skilled in the art will appreciate, the present examples are suitable for application in a variety of different types of networks (e.g. over a corporate network, a local area network etc). It will also be appreciated that the method may be performed by an entity which is not a web server. For example, the web server 101 may act as an interface between the entity performing the searching and/or compiling of the information found in the search and the network. It will further be appreciated that one or more of the method steps may be performed by different apparatus (e.g. a first apparatus may extract the tag information and a second apparatus may perform the searching for additional information such as specifications).

Although the examples described above show the method being run on a central resource (e.g. web server 101), the method may alternatively be performed in a distributed manner e.g. on the seller's PC 102 or on any user's device, such as a PC, PDA, mobile telephone etc to enable them to locally create a collection of data on an item which may then be uploaded to a website, distributed or otherwise used.

The term ‘computer’ is used herein to refer to any device with processing capability such that it can execute instructions. Those skilled in the art will realize that such processing capabilities are incorporated into many different devices and therefore the term ‘computer’ includes PCs, servers, mobile telephones, personal digital assistants and many other devices.

The methods described herein may be performed by software in machine readable form on a storage medium. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

The steps of the methods described herein may be carried out in any suitable order, or simultaneously where appropriate.

It will be understood that the benefits and advantages described above may relate to one embodiment or may relate to several embodiments. It will further be understood that reference to ‘an’ item refer to one or more of those items. For example, in the method shown in FIG. 2 and described above, the step of receiving ‘an image’ (step 201) could comprise receiving a single image or multiple images and the image may be a still image or a moving image.

It will be understood that the above description of a preferred embodiment is given by way of example only and that various modifications may be made by those skilled in the art. The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention.

1. A method comprising:
receiving an image of an item, said image comprising embedded data relating to said item;
extracting said embedded data from said image;
searching for information relating to said item based on said extracted embedded data; and
compiling said information relating to said item to create compiled information.

2. A method according to claim 1, wherein said image comprises a still image.

3. A method according to claim 1, wherein said image comprises a moving image.

4. A method according to claim 1, wherein said compiled information comprises a presentation about said item.

5. A method according to claim 4, wherein said presentation comprises a sales presentation.

6. A method according to claim 1, further comprising:
publishing said compiled information on a website.

7. A method according to claim 6, wherein said website comprises an online auction website.

8. A method according to claim 1, further comprising:
categorizing said item based on said extracted embedded data.

9. A method according to claim 8, further comprising:
publishing said compiled information on a website based on said categorization.

10. A method according to claim 1, wherein said item comprises a used item.

11. A method according to claim 1, wherein said embedded data comprises an electronic product code.

12. A method according to claim 1, wherein said information comprises one or more of: specification information, operating instructions, safety information and valuation details.

13. A method according to claim 1, wherein searching for information relating to said item based on said extracted embedded data comprises:
identifying a manufacturer of said item using said extracted embedded data; and
searching for information relating to said item on a website associated with said manufacturer.

14. One or more device-readable media with device-executable instructions for performing steps comprising:
receiving an image of an item, said image comprising embedded data relating to said item;
extracting said embedded data from said image;
searching for information relating to said item based on said extracted embedded data; and
compiling said information relating to said item to create compiled information.

15. An apparatus comprising:
a processor;
an input; and
a memory arranged to store executable instructions arranged to cause the processor to:
extract embedded data from an image received via said input, said image showing an item and comprising embedded data relating to said item;
search for information relating to said item based on said extracted embedded data; and
compile said information relating to said item to create compiled information.

16. An apparatus according to claim 15, wherein said memory is further arranged to store executable instructions arranged to cause the processor to:
publish said compiled information on a website.

17. An apparatus according to claim 16, wherein said website comprises an online auction website.

18. An apparatus according to claim 15, wherein said image comprises a still image.

19. An apparatus according to claim 15, wherein said image comprises a moving image.
